(19) United States
(12) Patent Application Publication
(10) Pub. No.: US 2016/0297118 A1
(43) Pub. Date: Oct. 13, 2016

(54) METHOD FOR FORMING VEHICLE GLASS ENCAPSULATION, VEHICLE WINDOW AND MOLD

(71) Applicants: Zhizhao YU, Shanghai (CN); Lu LIU, Shanghai (CN); Jun ZHOU, Shanghai (CN)

(72) Inventors: Zhizhao YU, Shanghai (CN); Lu LIU, Shanghai (CN); Jun ZHOU, Shanghai (CN)

(21) Appl. No.: 15/036,834

(22) PCT Filed: Nov. 20, 2014
(86) PCT No.: PCT/CN2014/091719

§ 371 Date: May 16, 2016

(30) Foreign Application Priority Data
Nov. 22, 2013 (CN) 201310597096.X

(51) Int. Cl. B29C 44/04; B29C 45/74; B29C 45/20; B29C 45/14

(52) U.S. Cl. CPC B29C 44/0407; B29C 45/14434; B29C 45/74; B29C 45/20; B29K 2027/06

(57) ABSTRACT

A method for forming a vehicle glass encapsulation, a vehicle window and a mold are provided. The method includes: forming a polymer solution containing bubble nuclei, the bubble nuclei being formed by a foaming agent; and performing an injection molding process by injecting the polymer solution containing the bubble nuclei into a mold in a way where the bubble nuclei is restrained from growing on at least a part of an inner wall of a cavity of the mold, to form the vehicle glass encapsulation. The formed vehicle glass encapsulation may have no chromatic aberration and raised grain.

### CROSS-REFERENCE TO RELATED APPLICATIONS

The present application claims priority to Chinese Patent Application No. 201310597096.X, filed on Nov. 22, 2013, and entitled “METHOD FOR FORMING VEHICLE GLASS ENCAPSULATION, VEHICLE WINDOW AND MOLD”, and the entire disclosure of which are incorporated herein by reference.

### TECHNICAL FIELD

The present disclosure generally relates to glass technology field, and more particularly, to a method for forming a vehicle glass encapsulation, a vehicle window encapsulated using the method, and a mold for forming a vehicle glass encapsulation.

### BACKGROUND

Glass encapsulation can enhance sealing between a glass and a vehicle bodywork, reduce noises resulted from airflow passing spaces between the glass and the vehicle bodywork, and improve safety and aesthetics of the glass.

A vehicular rear triangular window assembly is shown in FIG. 1. The vehicular rear triangular window assembly includes: a glass 11 and a glass encapsulation 12 formed around the glass 11. The glass encapsulation 12 includes a glue surface 121, a lip 122 and a glue accommodation groove 123. The glue accommodation groove 123 is formed on the glue surface 121 and adapted to accommodating glass glue. The glue accommodation groove 123 can prevent the glass glue from flowing transversely, and thus a leak of glue can be avoided. The lip 122 is sheet-shaped and can deform when squeezed. The glass encapsulation 12 is formed by an injection molding process.

The injection molding process includes: plasticizing a raw material to form a solution; injecting the solution into a mold cavity; and cooling and curing the solution in the mold cavity. In this manner, an injection molding component is formed having a shape matched with that of the mold cavity.

However, in existing injection molding processes for forming a glass encapsulation, a solution may shrink in a mold cavity during cooling, thus, a size of the formed glass encapsulation may be smaller than a design specification. As a result, the glass encapsulation may not be well matched with other components of a vehicle window. For example, the glass encapsulation does not match a bright decoration strip during installation of the vehicle window, which leads to a gap between them.

To avoid the above shrinkage problem, an injection pressure is increased during an injection molding process. However, the increased injection pressure may cause a fracture of glass, which may reduce a yield of fabricating glass encapsulation. Therefore, a method for forming a vehicle glass encapsulation is required.

### SUMMARY

A method for forming vehicle glass encapsulation is provided, where shrinkage of a plasticization solution due to cooling in a mold cavity is controlled during an injection molding process and the formed vehicle glass encapsulation basically has no chromatic aberration and raised grain.

In one aspect, a method for forming a vehicle glass encapsulation is provided. The method includes: forming a polymer solution containing bubble nuclei, the bubble nuclei being formed by a foaming agent; and performing an injection molding process by injecting the polymer solution containing the bubble nuclei into a mold in a way where the bubble nuclei is restrained from growing on at least a part of an inner wall of a cavity of the mold, to form the vehicle glass encapsulation.

A basic principle lies in that, by employing the polymer solution containing bubble nuclei, the bubble nuclei may grow into bubbles to compensate shrinkage of a plasticization solution (the polymer solution) during cooling in the cavity, and the bubble nuclei is restrained from growing on the at least a part of the inner wall of the cavity of the mold which corresponds to an external surface of the vehicle glass encapsulation. In this way, the external surface of the formed vehicle glass encapsulation basically has no bubble, no chromatic aberration and no raised grain. In some embodiments, restraining the bubble nuclei from growing on at least a part of an inner wall of the cavity of the mold may include: cooling the at least a part of the inner wall of the cavity of the mold. During a mold filling process, the polymer solution flows along the inner wall of the cavity, and the continuous injected polymer solution gradually fills the cavity. By cooling the inner wall of the cavity, a temperature of polymer close to the inner wall decreases relatively rapidly and the polymer close to the inner wall crystallizes or forms an amorphous shell rapidly, which thus restrains the bubble nuclei from growing. Further, the polymer generally has a poor thermal conductivity, thus a temperature of the polymer solution inside the cavity may not decrease rapidly and the bubble nuclei in the polymer solution inside the cavity can grow up. As the bubble nuclei in the polymer solution inside the cavity grow, a large pressure may be generated and applied to the polymer solution close to the inner wall of the cavity, which further restrains the bubble nuclei in the polymer solution close to the inner wall of the cavity from growing. In this way, the resulting glass encapsulation may have a dense external surface and a porous inside structure.

In some embodiments, restraining the bubble nuclei from growing on at least a part of an inner wall of the cavity of the mold may include: before injecting the polymer solution containing bubble nuclei into the mold, decreasing a temperature of the polymer solution. During a mold filling process, the polymer solution flows along the inner wall of the cavity, and the continuous injected polymer solution gradually fills the cavity. As a temperature of the injected polymer is decreased and the polymer close to the inner wall of the cavity radiates heat through the inner wall of the cavity, a temperature of the polymer close to the inner wall decreases relatively rapidly. The polymer close to the inner wall may crystallize or form an amorphous shell rapidly, which thus restrains the bubble nuclei from growing. Further, the polymer generally has a poor thermal conductivity, thus a temperature of the polymer solution inside the cavity may not decrease rapidly and the bubble nuclei in the polymer solution inside the cavity can grow up. As the bubble nuclei in the polymer solution inside the cavity grow, a large pressure may be generated and applied to the polymer solution close to the inner wall of the cavity, which further restrains the bubble nuclei in the polymer solution close to the inner wall of the cavity from growing. In this way, the resulting glass encapsulation has a dense external surface and a porous inside structure. In some embodiments, restraining the bubble nuclei from growing on at least a part of an inner wall of the cavity of the mold may include: disposing an extended injection pipeline at an inlet of the mold. The extended injection pipeline can decrease a temperature of the polymer injected into the mold during a mold filling process. During the mold filling process, the polymer solution flows along the inner wall of the cavity, and the continuous injected polymer solution gradually fills the cavity. As a temperature of the injected polymer is decreased and the polymer close to the inner wall of the cavity radiates heat through the inner wall of the cavity, a temperature of the polymer close to the inner wall decreases relatively rapidly. The polymer close to the inner wall may crystallize or form an amorphous shell rapidly, which thus restrains the bubble nuclei from growing. Further, the polymer generally has a poor thermal conductivity, thus a temperature of the polymer solution inside the cavity may not decrease rapidly and the bubble nuclei in the polymer solution inside the cavity can grow up. As the bubble nuclei in the polymer solution inside the cavity grow, a large pressure may be generated and applied to the polymer solution close to the inner wall of the cavity, which further restrains the bubble nuclei in the polymer solution close to the inner wall of the cavity from growing. In this way, the resulting glass encapsulation has a dense external surface and a porous inside structure.

In some embodiments, restraining the bubble nuclei from growing on at least a part of an inner wall of the cavity of the mold may include: cooling a gate of the mold. By cooling the gate of the mold, a temperature of the polymer injected into the mold can be decreased during a mold filling process. During the mold filling process, the polymer solution flows along the inner wall of the cavity, and the continuous injected polymer solution gradually fills the cavity. As a temperature of the injected polymer is decreased and the polymer close to the inner wall of the cavity radiates heat through the inner wall of the cavity, the temperature of the polymer close to the inner wall decreases relatively rapidly. The polymer close to the inner wall may crystallize or form an amorphous shell rapidly, which thus restrains the bubble nuclei from growing. Further, the polymer generally has a poor thermal conductivity, thus a temperature of the polymer solution inside the cavity may not decrease rapidly and the bubble nuclei in the polymer solution inside the cavity can grow up. As the bubble nuclei in the polymer solution inside the cavity grow, a large pressure may be generated and applied to the polymer solution close to the inner wall of the cavity, which further restrains the bubble nuclei in the polymer solution close to the inner wall of the cavity from growing. In this way, the resulting glass encapsulation has a dense external surface and a porous inside structure.

In some embodiments, the method may further include: during the injection molding process, exhausting gases in the mold, which may prevent the bubble nuclei from being formed on a surface of the vehicle glass encapsulation to restrain chromatic aberration and raised grain of the vehicle glass encapsulation.

In another aspect, a vehicle window is provided, wherein an encapsulation is formed using any of the above method.

A basic principle lies in that, by employing the polymer solution containing bubble nuclei, the bubble nuclei may grow into bubbles to compensate shrinkage of a plasticization solution during cooling in the cavity, and the bubble nuclei may be restrained from growing on the at least a part of the inner wall of the cavity of the mold which corresponds to an external surface of the vehicle glass encapsulation. In this way, the external surface of the formed vehicle glass encapsulation basically has no bubble, no chromatic aberration and no raised grain.

In another aspect, a mold for forming a vehicle glass encapsulation is provided. An extended injection pipeline is disposed at an inlet of the mold, and/or a cooling device is disposed at a gate of the mold, wherein an inside of the vehicle glass encapsulation has a porous structure, and a surface of the vehicle glass encapsulation is denser than the inside thereof. The mold can decrease a temperature of the polymer injected into the mold during a mold filling process. During the mold filling process, the polymer solution flows along the inner wall of the cavity, and the continuous injected polymer solution gradually fills the cavity. As a temperature of the injected polymer is decreased and the polymer close to the inner wall of the cavity radiates heat through the inner wall of the cavity, the temperature of the polymer close to the inner wall decreases relatively rapidly. The polymer close to the inner wall may crystallize or form an amorphous shell rapidly, which thus restrains the bubble nuclei from growing. Further, the polymer generally has a poor thermal conductivity, thus a temperature of the polymer solution inside the cavity may not decrease rapidly and the bubble nuclei in the polymer solution inside the cavity can grow up. As the bubble nuclei in the polymer solution inside the cavity grow, a large pressure may be generated and applied to the polymer solution close to the inner wall of the cavity, which further restrains the bubble nuclei in the polymer solution close to the inner wall of the cavity from growing. In this way, the resulting glass encapsulation has a dense external surface and a porous inside structure.

### BRIEF DESCRIPTION OF THE DRAWINGS

FIG. 1 schematically illustrates a vehicular rear triangular window assembly in existing techniques;

FIG. 2 schematically illustrates a flow chart of a method for forming a vehicle glass encapsulation according to an embodiment of the present disclosure;

FIG. 3 schematically illustrates a flow chart of a method for forming a polymer solution containing bubble nuclei according to an embodiment of the present disclosure;

FIG. 4 schematically illustrates a glass encapsulation formed by a method for forming a vehicle glass encapsulation provided in an embodiment of the present disclosure;

FIG. 5 schematically illustrates a cross-sectional view of the vehicle glass encapsulation along an AA line shown in FIG. 4; and

FIG. 6 schematically illustrates a mold for forming a vehicle glass encapsulation according to an embodiment of the present disclosure.

### DETAILED DESCRIPTION

As described in background, when employing an injection molding process to form a glass encapsulation, a plasticization solution may cool down and shrink in a mold cavity, thus, the formed glass encapsulation may have a size smaller than a design specification and a sink mark may be generated on a surface of the glass encapsulation. In the existing techniques, to restrain the shrinkage of the solution, injection pressure is increased during the injection molding process. However, the increased injection pressure may be prone to cause a fracture of glass.

In embodiments of the present disclosure, a plasticization solution (a polymer solution) containing bubble nuclei is formed and injected into a mold to perform an injection molding process, to form a vehicle glass encapsulation. The plasticization solution containing bubble nuclei may have a high flowability, thereby reducing a molding temperature in the plasticization process. As a result, heating time and a molding period may be shortened, producing efficiency may be increased, a temperature difference in the plasticization process may be reduced, and shrinkage of the plasticization solution during cooling may be restrained.

After the plasticization solution containing bubble nuclei is injected into a cavity of the mold, the plasticization solution is cooled and cured in the cavity to form the vehicle glass encapsulation. During the process, as an outside temperature decreases, the plasticization solution may shrink naturally. Besides, a screw-type plasticization device or a plunger-type plasticization device is generally used to realize plasticization. During the injection molding process and the curing process, pressure in the cavity of the mold is lower than that in a plasticization device, so that the bubble nuclei gradually grow into bubbles due to the decrease of pressure. The expansion of the bubble nuclei and the shrinkage of the plasticization solution may compensate each other, which restrains shrinkage of the vehicle glass encapsulation.

However, bubbles are prone to be formed on a surface of the vehicle glass encapsulation due to the plasticization solution containing bubble nuclei used in the injection molding process, thus, the surface may become rough and the vehicle glass encapsulation may have chromatic aberration and raised grain. Generally, users have high requirements for the appearance of external members of a vehicle. Therefore, there is a need to provide a method for restraining a plasticization solution from shrinking in a cavity of a mold which method can form a product having no chromatic aberration and raised grain.

Based on above research, in an embodiment of the present disclosure, a polymer solution containing bubble nuclei is formed and injected into a mold in a way where the bubble nuclei is restrained from growing on at least a part of an inner wall of a cavity of the mold, to perform an injection molding process. In this manner, a surface of a formed vehicle glass encapsulation basically has no chromatic aberration and raised grain, and shrinkage of the polymer solution is restrained in the cavity of the mold.

Hereinafter, embodiments of the present disclosure may be described in detail. It should be noted that, the embodiments below are only examples of ways to implement and apply the present disclosure but do not limit the scope of the present disclosure.

The above objects, characteristics and advantages of the disclosure may be better understood by referring to the following description in conjunction with accompanying figures.

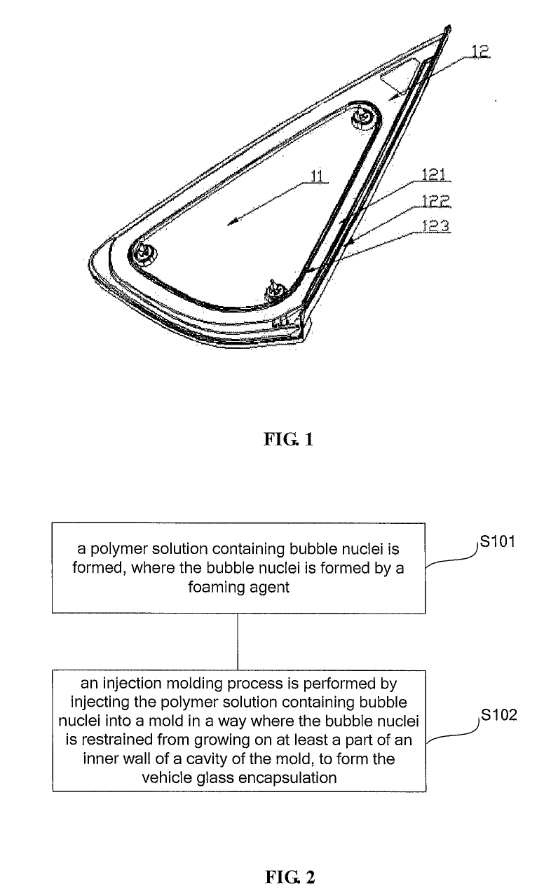

FIG. 2 schematically illustrates a flow chart of a method for forming a vehicle glass encapsulation according to an embodiment of the present disclosure. The method includes steps S101 and S102.

In S101, a polymer solution containing bubble nuclei is formed, where the bubble nuclei is formed by a foaming agent.

In some embodiments, the polymer solution may be used in injection molding of a vehicular external member (for example, a glass) to form a glass encapsulation. In some embodiments, the polymer solution may include Polyvinyl Chloride (PVC), Thermoplastic Elastomer (TPE) or other suitable materials.

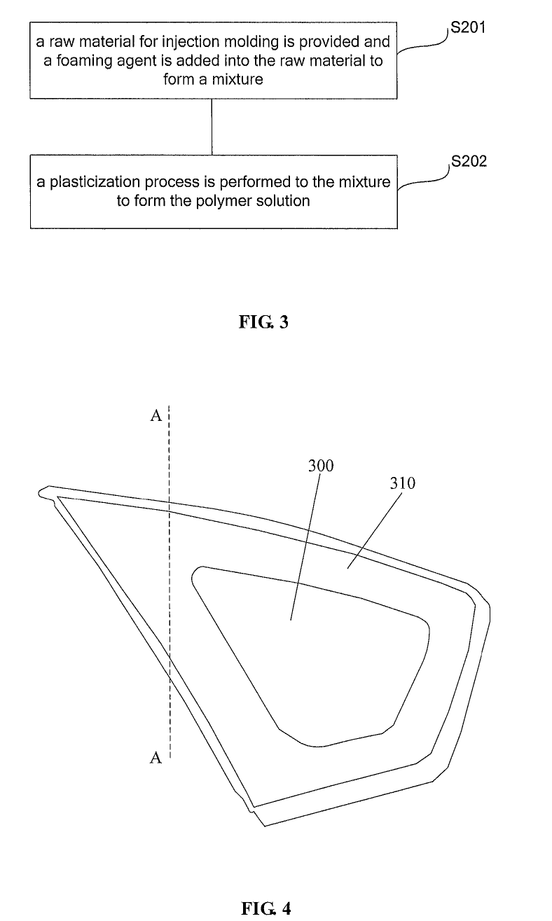

Referring to FIG. 3, forming the polymer solution containing bubble nuclei includes steps S201 and S202.

In S201, a raw material for injection molding is provided and a foaming agent is added into the raw material to form a mixture.

In some embodiments, the raw material may be PVC particles or TPE particles. In subsequent processes, a plasticization process may be performed to the mixture to form the polymer solution.

In some embodiments, the foaming agent may be a physical foaming agent or a chemical foaming agent. In some embodiments, the physical foaming agent may include at least one selected from compressed air, chlorinated aliphatics (for example, methane chloride, dichloromethane or dichloroethane), alcohol and ether.

In some embodiments, the chemical foaming agent may include at least one selected from ammonium salt, sodium bicarbonate, sodium nitrite, azoic compound, sulfonyl hydrazine compound, nitroso compound, azodicarbonamide and azobisisobutyronitrile.

In some embodiments, a physical foaming agent or a chemical foaming agent may be added into the raw material for injection molding during the plasticization process performed to the raw material.

In some embodiments, when the foaming agent is a physical foaming agent, a ratio of the mass of the physical foaming agent to the mass of the raw material and the physical foaming agent may be within a range from 0.2% to 10%, thereby enabling the polymer solution to have moderate bubble nuclei.

In some embodiments, when the foaming agent is a chemical foaming agent, a ratio of the mass of the chemical foaming agent to the mass of the raw material and the chemical foaming agent may be within a range from 0.2% to 10%, thereby enabling the polymer solution to have moderate bubble nuclei.

Still referring to FIG. 3, in S202, a plasticization process is performed to the mixture to form the polymer solution.

In some embodiments, the plasticization process may be performed using a plasticization device which enables the mixture to be plasticized to form the polymer solution.

In some embodiments, the plasticization device includes a plasticization charging barrel, a machine barrel and a heating unit. The plasticization charging barrel is adapted to holding the mixture. The machine barrel is interlinked with the plasticization charging barrel and has a hollow cavity disposed therein. The mixture enters into the hollow cavity through the plasticization charging barrel. The heating unit is adapted to heating the mixture in the machine barrel to fulfill the plasticization process. During the plasticization process, the mixture having particles may be heated to melt to form a fluid polymer solution. Generally, the plasticization device may be a plunger-type plasticization device or a screw-type plasticization device.

During the plasticization process, the foaming agent contained in the mixture may generate bubble nuclei under a physical or chemical function. Further, under the push of a plunger or a screw, pressure in the hollow cavity may be relatively large and the bubble nuclei may not grow into bubbles.

Referring to FIG. 2, in S102, an injection molding process is performed by injecting the polymer solution containing bubble nuclei into a mold in a way where the bubble nuclei is restrained from growing on at least a part of an inner wall of a cavity of the mold, to form the vehicle glass encapsulation.

The mold includes the cavity which is matched with the vehicle glass encapsulation to be formed.

In some embodiments, performing an injection molding process by injecting the polymer solution containing bubble nuclei into a mold to form the vehicle glass encapsulation may include: injecting the polymer solution containing the bubble nuclei into the cavity; and cooling and curing the polymer solution under a molding temperature, to form the vehicle glass encapsulation.

During the injection molding process, as the molding temperature is lower than a melting temperature of the raw material for injection molding, the polymer solution may shrink naturally. Besides, pressure in the cavity of the mold is lower than that in a plasticization device, so that the bubble nuclei gradually grow into bubbles due to the decrease of pressure. The expansion of the bubble nuclei and the shrinkage of the polymer solution may compensate each other, which restrains shrinkage of the vehicle glass encapsulation.

It should be noted that, in some embodiments, to further restrain the shrinkage of the vehicle glass encapsulation, holding pressure may be applied to the polymer solution during the injection molding process. However, in above embodiments, the foaming agent is employed to restrain the shrinkage, thus, it is possible not to provide any holding pressure or only provide low holding pressure to the polymer solution, so as to avoid fracture of glass caused by too high holding pressure and to further improve production yield.

Besides, the polymer solution containing bubble nuclei may have good flowability. Pressure injected into the polymer solution should be lower so that glass may not fracture. The polymer solution having good flowability may provide better filling effect for the mold, which is helpful to form a vehicle glass encapsulation having a complicated structure.

Further, the vehicle glass encapsulation formed with the polymer solution containing bubble nuclei may have micropores, thereby reducing materials and weight of the vehicle glass encapsulation.

In the embodiment, the injection molding process is performed by injecting the polymer solution containing the bubble nuclei into the mold in the way where the bubble nuclei is restrained from growing on at least a part of the inner wall of the cavity of the mold, to form the vehicle glass encapsulation, which may restrain shrinkage of the polymer solution in the cavity of the mold, and the formed vehicle glass encapsulation basically has no chromatic aberration and raised grain.

Restraining the bubble nuclei from growing on at least a part of the inner wall of the cavity of the mold means the bubble nuclei do not grow into bubbles at positions which correspond to a surface of the vehicle glass encapsulation. In the existing techniques, sink marks may be generated on a surface of a vehicle glass encapsulation when gases in bubbles are not exhausted. However, in embodiments of the present disclosure, the bubble nuclei contains few gases, thus, no sink mark will be generated on the surface of the vehicle glass encapsulation, which further avoids chromatic aberration and raised grain. Besides, at positions not corresponding to the surface of the vehicle glass encapsulation, the bubble nuclei may still grow into bubbles. The expansion of the bubble nuclei and the shrinkage of the polymer solution may compensate each other, that is to say, the shrinkage of the polymer resolution in the cavity of the mold is restrained, which enables a size of the vehicle glass encapsulation to be consistent with a design specification and basically no chromatic aberration and raised grain may be generated on the surface of the vehicle glass encapsulation.

In some embodiments, restraining the bubble nuclei from growing on at least a part of the inner wall of the cavity of the mold may include restraining the bubble nuclei from growing on the whole inner wall of the cavity of the mold. In some embodiments, restraining the bubble nuclei from growing on at least a part of the inner wall of the cavity of the mold may include restraining the bubble nuclei from growing on a portion of the inner wall of the cavity of the mold.

In some embodiments, the vehicle glass encapsulation formed by the above method where the bubble nuclei is restrained from growing on the whole inner wall of the cavity of the mold basically has no chromatic aberration and raised grain generated on the surface thereof. In some embodiments, it is only required that a portion of the surface of the vehicle glass encapsulation have no chromatic aberration and raised grain, thus, the bubble nuclei may be restrained from growing on only a portion of the inner wall of the cavity of the mold, which can reduce cost of processes.

In some embodiments, restraining the bubble nuclei from growing on at least a part of the inner wall of the cavity of the mold may include cooling at least a part of the inner wall of the cavity.

In some embodiments, the polymer solution may be injected into the cavity using an injection device.

When the injection device injects the polymer solution into the cavity, the pressure in the cavity is lower than that in the injection device, thus the bubble nuclei may gradually grow due to the pressure difference. The molding temperature during the injection molding process should be lower than the melting temperature of the raw material for injection molding. In some embodiments, the molding temperature may be within a range from 130° C. to 210° C. In the embodiment, by cooling the inner wall of the cavity, a temperature of the polymer close to the inner wall decreases relatively rapidly and the polymer close to the inner wall crystallizes or forms an amorphous shell rapidly, which thus restrains the bubble nuclei from growing. Further, the polymer generally has a poor thermal conductivity, thus a temperature of the polymer solution inside the cavity may not decrease rapidly and the bubble nuclei in the polymer solution inside the cavity can grow up. As the bubble nuclei in the polymer solution inside the cavity grow, a large pressure may be generated and applied to the polymer solution close to the inner wall of the cavity, which further restrains the bubble nuclei in the polymer solution close to the inner wall of the cavity from growing. In this way, an external surface of the resulting glass encapsulation basically has no bubble or few bubbles formed thereon.

In some embodiments, the at least a part of the inner wall of the cavity may be cooled under a temperature within a range from 8° C. to 20° C., such as 8° C., 10° C., 15° C. or 20° C. The above temperature may form a good temperature difference with the molding temperature within the range from 130° C. to 210° C.

Any suitable cooling methods may be performed to the inner wall of the cavity to cool it. In some embodiments, a channel which surrounds the inner wall of the cavity may be formed, and cooling water may be injected into the channel during the injection molding process, to cool the inner wall of the cavity.

In some embodiments, restraining the bubble nuclei from growing on at least a part of the inner wall of the cavity of the mold may include: injecting the polymer solution containing bubble nuclei into the mold under a pressure from 40 Kg/cm² to 90 Kg/cm². Based on plenty of experiments, it is found that the glass encapsulation formed by the process using the above parameters basically has no bubble formed on its surface and has a porous inside structure.

In some embodiments, restraining the bubble nuclei from growing on at least a part of the inner wall of the cavity of the mold may include: before injecting the polymer solution containing bubble nuclei into the mold, decreasing a temperature of the polymer solution. During a mold filling process, the polymer solution flows along the inner wall of the cavity, and the continuous injected polymer solution gradually fills the cavity. As a temperature of the injected polymer is decreased and the polymer close to the inner wall of the cavity may radiate heat through the inner wall of the cavity, a temperature of the polymer close to the inner wall may decrease relatively rapidly. The polymer close to the inner wall may crystallize or form an amorphous shell rapidly, which thus restrains the bubble nuclei from growing. Further, the polymer generally has a poor thermal conductivity, thus the temperature of the polymer solution inside the cavity may not decrease rapidly and the bubble nuclei in the polymer solution inside the cavity can grow up. As the bubble nuclei in the polymer solution inside the cavity grow, a large pressure may be generated and applied to the polymer solution close to the inner wall of the cavity, which further restrains the bubble nuclei in the polymer solution close to the inner wall of the cavity from growing. In this way, the resulting glass encapsulation has a dense external surface and a porous inside structure.

In some embodiments, restraining the bubble nuclei from growing on at least a part of the inner wall of the cavity of the mold may include cooling a gate of the mold.

The gate is a last toll-gate before the polymer solution enters the cavity through a pouring system. By cooling the gate, the temperature of the polymer injected into the mold can be decreased during a mold filling process. During the mold filling process, the polymer solution flows along the inner wall of the cavity, and the continuous injected polymer solution gradually fills the cavity. As a temperature of the injected polymer is decreased and the polymer close to the inner wall of the cavity radiates heat through the inner wall of the cavity, the temperature of the polymer close to the inner wall decreases relatively rapidly. The polymer close to the inner wall may crystallize or form an amorphous shell rapidly, which thus restrains the bubble nuclei from growing. Further, the polymer generally has a poor thermal conductivity, thus a temperature of the polymer solution inside the cavity may not decrease rapidly and the bubble nuclei in the polymer solution inside the cavity can grow up. As the bubble nuclei in the polymer solution inside the cavity grow, a large pressure may be generated and applied to the polymer solution close to the inner wall of the cavity, which further restrains the bubble nuclei in the polymer solution close to the inner wall of the cavity from growing. In this way, the resulting glass encapsulation has a dense external surface and a porous inside structure.

Besides, cooling the gate of the mold may further avoid raised grain caused by an expansion effect when the polymer solution enters the cavity of the mold through the gate.

In some embodiments, the gate of the mold may be cooled, and the polymer solution may be injected into the cavity through a pipeline under the pressure from 40 Kg/cm² to 90 Kg/cm².

It should be noted that, the gate may be cooled under a particular temperature which is determined by a material of the polymer and other process parameters. The particular temperature may enable the temperature of the polymer solution injected into the cavity of the mold to decrease by a certain range (such as 5° C., 10° C. or 20° C.), and may not lead to great viscosity of the polymer solution which may result in some problems, such as under-injection. For example, to a polymer material (such as Polyethylene Terephthalate (PETP)) having a relatively high glass transition temperature, a temperature of the gate of the mold may be retained at 40° C. To a polymer material (such as Polypropylene (PP)) having a relatively low glass transition temperature, the temperature of the gate of the mold may be decreased by a relatively large range, for example, to be retained at 10° C.

The gate of the mold may be cooled by any suitable devices. In some embodiments, a channel surrounding the gate may be formed, and cooling water may be injected into the channel in the injection molding process, to cool the gate.

In some embodiments, restraining the bubble nuclei from growing on at least a part of the inner wall of the cavity of the mold may include disposing an extended injection pipeline at an inlet of the mold.

The extended injection pipeline can decrease the temperature of the polymer injected into the mold during a mold filling process. During the mold filling process, the polymer solution flows along the inner wall of the cavity, and the continuous injected polymer solution gradually fills the cavity. As a temperature of the injected polymer is decreased and the polymer close to the inner wall of the cavity radiates heat through the inner wall of the cavity, a temperature of the polymer close to the inner wall decreases relatively rapidly. The polymer close to the inner wall may crystallize or form an amorphous shell rapidly, which thus restrains the bubble nuclei from growing. Further, the polymer generally has a poor thermal conductivity, thus a temperature of the polymer solution inside the cavity may not decrease rapidly and the bubble nuclei in the polymer solution inside the cavity can grow up. As the bubble nuclei in the polymer solution inside the cavity grow, a large pressure may be generated and applied to the polymer solution close to the inner wall of the cavity, which further restrains the bubble nuclei in the polymer solution close to the inner wall of the cavity from growing. In this way, the formed glass encapsulation has a dense external surface and a porous inside structure. In some embodiments, the length of the extended injection pipeline may be determined base on practical requirements. That is, the length may enable the temperature of the polymer solution to decrease to a required temperature. For example, if the temperature of the polymer solution is required to decrease by a relatively large range, the length of the extended injection pipeline may be 5 cm. If the temperature of the polymer solution is required to decrease by a relatively small range, the length of the extended injection pipeline may be 1 cm.

Besides, to further restrain chromatic aberration and raised grain of the vehicle glass encapsulation, during the injection molding process, gases in the mold may be exhausted.

In some embodiments, the gases in the mold may be exhausted through an exhaust device arranged on the mold. In some embodiments, the exhaust device may include at least one exhaust hole on the mold. The exhaust hole may have a suitable diameter which ensures that the gases are exhausted and the polymer solution cannot be exhausted.

In some embodiments, the at least one exhaust hole may include a plurality of exhaust holes which are arranged on the mold uniformly to realize exhausting gases uniformly, which ensures the vehicle glass encapsulation to have a smooth surface. Besides, exhausting gases in the mold may also prevent bubbles from being formed on the surface of the vehicle glass encapsulation and further restrain chromatic aberration and raised grain of the vehicle glass encapsulation.

In some embodiments, the exhaust device may include at least one exhaust needle on the mold. The gases in the mold may be exhausted through the at least one exhaust needle.

In some embodiments, to restrain chromatic aberration and raised grain of the vehicle glass encapsulation, the at least one exhaust needle may be arranged at a position in the mold that corresponds to the back of the vehicle glass encapsulation. The back of the vehicle glass encapsulation may denote to a side of the vehicle glass encapsulation which faces a vehicle bodywork during installation.

In some embodiments, the exhaust device may be an evacuation device connected with the mold which can evacuate gases between the vehicle glass encapsulation and the inner wall of the cavity of the mold. The evacuation device has good controllability and ensures good exhaust effect.

In an embodiment, a vehicle window which is formed by the above method is provided. Referring to FIG. 4, the vehicle window includes a glass 300 and a vehicle glass encapsulation structure 310 at any side of the glass 300 which is formed by the above method.

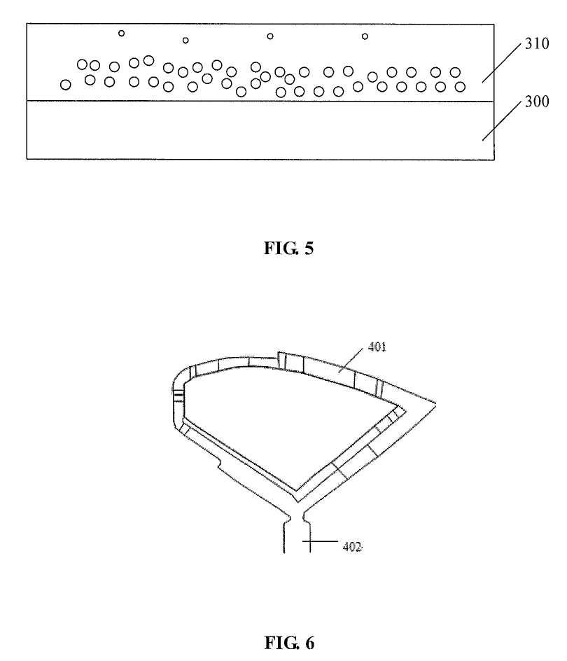

Referring to FIG. 5, FIG. 5 schematically illustrates a cross-sectional view of the vehicle glass encapsulation structure 310 along an AA line shown in FIG, 4. From FIG. 5, a surface of the vehicle glass encapsulation structure 310 basically has no micropore generated by bubbles, or only has few small micropores generated by bubble nuclei, while the inside of the vehicle glass encapsulation structure 310 has plenty of micropores.

In an embodiment, a mold for forming a vehicle glass encapsulation is provided. Referring to FIG. 6, the mold includes a base 401 and an extended injection pipeline 402. The base 401, which contains a cavity matched with a shape of vehicle glass to be injected, is adapted to performing an injection process to the vehicle glass to be injected, The extended injection pipeline 402 is adapted to inletting a polymer solution.

The extended injection pipeline 402 can decrease a temperature of the polymer injected into the mold during a mold filling process. During the mold filling process, the polymer solution flows along an inner wall of the cavity, and the continuous injected polymer solution gradually fills the cavity. As a temperature of the injected polymer is decreased and the polymer close to the inner wall of the cavity radiates heat through the inner wall of the cavity, the temperature of the polymer close to the inner wall decreases relatively rapidly. The polymer close to the inner wall may crystallize or form an amorphous shell rapidly, which thus restrains the bubble nuclei from growing. Further, the polymer generally has a poor thermal conductivity, thus a temperature of the polymer solution inside the cavity may not decrease rapidly and the bubble nuclei in the polymer solution inside the cavity can grow up. As the bubble nuclei in the polymer solution inside the cavity grow, a large pressure may be generated and applied to the polymer solution close to the inner wall of the cavity, which further restrains the bubble nuclei in the polymer solution close to the inner wall of the cavity from growing. In this way, the resulted glass encapsulation has a dense external surface and a porous inside structure.

In some embodiments, a cooling device may be disposed at a gate of the mold, which may decrease the temperature of the polymer injected into the cavity of the mold during the mold filling process.

In some embodiments, the mold may further include an exhaust device, such as an exhaust hole, an exhaust needle or an evacuation device.

The exhaust device may be adapted to exhausting gases in the mold during an injection molding process, so that bubbles at the inner wall of the cavity can be exhausted during the injection process, which may restrain chromatic aberration and raised grain of the formed vehicle glass encapsulation.

It should be noted that, the above embodiments may be combined. For example, both an extended injection pipeline is provided and an inner wall of a cavity of a mold is cooled.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure. Therefore, the protection scope of the present disclosure is subject to the scope defined by the claims.

1. A method for forming a vehicle glass encapsulation, comprising:
forming a polymer solution containing bubble nuclei, the bubble nuclei being formed by a foaming agent; and
performing an injection molding process by injecting the polymer solution containing the bubble nuclei into a mold in a way where the bubble nuclei is restrained from growing on at least a part of an inner wall of a cavity of the mold, to form the vehicle glass encapsulation.

2. The method according to claim 1, wherein restraining the bubble nuclei from growing on at least a part of an inner wall of the cavity of the mold comprises: cooling at least a part of the inner wall of the cavity.

3. The method according to claim 2, wherein a temperature of the at least a part of the inner wall of the cavity is within a range from 8° C. to 20° C.

4. The method according to claim 1, wherein restraining the bubble nuclei from growing on at least a part of an inner wall of the cavity of the mold comprises: before injecting the polymer solution containing the bubble nuclei into the mold, decreasing a temperature of the polymer solution.

5. The method according to claim 4, wherein restraining the bubble nuclei from growing on at least a part of an inner wall of the cavity of the mold comprises: disposing an extended injection pipeline at an inlet of the mold.

6. The method according to claim 4, wherein restraining the bubble nuclei from growing on at least a part of an inner wall of the cavity of the mold comprises: cooling a gate of the mold.

7. The method according to claim 1, wherein restraining the bubble nuclei from growing on at least a part of an inner wall of the cavity of the mold comprises: injecting the polymer solution containing the bubble nuclei into the mold under a pressure from 40 Kg/cm² to 90 Kg/cm².

8. The method according to claim 1, further comprising: during the injection molding process, exhausting gases in the mold.

9. The The method according to claim 1, wherein a ratio of the mass of the foaming agent to the mass of an injection raw material is within a range from 0.2% to 10%.

10. The The method according to claim 1, wherein the foaming agent comprises a physical foaming agent or a chemical foaming agent.

11. The method according to claim 1, wherein the polymer solution comprises polyvinyl chloride or thermoplastic elastomer.

12. The method according to claim 1, wherein forming a polymer solution containing bubble nuclei comprises:
providing an injection raw material;
adding the foaming agent into the injection raw material to form a mixture; and
performing a plasticization process to the mixture to form the polymer solution.

13. A vehicle window, wherein an encapsulation is formed using a method according to claim 1.

14. A mold for forming a vehicle glass encapsulation, wherein an extended injection pipeline is disposed at an inlet of the mold, and/or a cooling device is disposed at a gate of the mold, an inside of the vehicle glass encapsulation has a porous structure, and a surface of the vehicle glass encapsulation is denser than the inside thereof.
